(19) United States
(12) Patent Application Publication
(10) Pub. No.: US 2020/0031213 A1
(43) Pub. Date: Jan. 30, 2020

(54) FLUSH GLAZED DEVICE FOR A VEHICLE DOOR, DOOR, MOTOR VEHICLE, AND CORRESPONDING PRODUCTION METHOD AND SINGLE-PIECE SEALING DEVICE

(71) Applicants: ADVANCED COMFORT SYSTEMS FRANCE SAS-ACS FRANCE, Bressuire (FR); COOPER STANDARD FRANCE S.A.S, Rennes (FR)

(72) Inventors: Philippe CHARGE, Bressuire (FR); Patrice GRAS, Saint-M'herve (FR)

(21) Appl. No.: 16/483,347

(22) PCT Filed: Feb. 13, 2018
(86) PCT No.: PCT/EP2018/053577

§ 371 Date: Aug. 2, 2019

(30) Foreign Application Priority Data
Feb. 15, 2017 (FR) 1751224

(51) Int. Cl. B60J 10/88; B60J 10/79; B60J 1/17; B60J 5/04

(52) U.S. Cl. CPC B60J 10/88; B60J 10/79; E05Y 2900/55; B60J 5/0402; B60J 1/17

(57) ABSTRACT

A glazed device is configured to be assembled to a door casing to form a vehicle door comprising a frame having an upper cross member connecting two jambs each formed by a sliding guide rail of a mobile glazed panel having a guide glide mounted slidingly with respect to one of the guide rails. The glazed device further comprises at least one sealing device comprising having an upper portion that forms the upper cross member of the frame, said upper portion including first sealing means configured to come into contact with the body of the vehicle when the door is closed, and second sealing means configured to come into contact with the mobile glazed panel wherein the upper portion, the first door sealing means and the second glazing sealing means are manufactured as a single piece.

### FIELD OF THE INVENTION

The field of the invention is that of motor vehicles.

More specifically, the invention relates to vehicle doors, and in particular the equipment of recesses formed in such doors.

Still more specifically, the invention relates to vehicle doors equipped with at least one glazed panel capable of moving substantially vertically, in particular in order to go from a closed position to an open position in which it integrally or partially penetrates a lower body casing (the mobile panel of course being capable of generally adopting a plurality of intermediate positions).

Such a vehicle door may in particular be a side door, but the invention may also be applied, for example, to swinging and/or sliding doors of a vehicle, including rear doors, hatches, and so on.

### PRIOR ART

Examples of such glazed devices are described in particular in patent documents EP 0 778 168 and EP 0 857 844.

According to this approach, a frame is provided, on the side facing the interior of the vehicle, with one or more (conventionally two) rails, cooperating with glides secured to the mobile glazed panel, and attached on the face thereof oriented toward the interior of the vehicle. The frame may, depending on the circumstances, be truncated and limited to jambs with rails.

This technique is beneficial because it makes it possible to conceive original designs, due to the removal of the conventional door frame, while preserving effective guiding and support of the mobile panel.

Patent document FR 2 872 094 discloses a technique making it possible to produce motor vehicle doors on which the glazed surface is flush-mounted (i.e. in which no frame is visible from the outside) and consisting in separately producing a door structure and a glazed assembly, which are assembled by stacking in order to form a vehicle door.

Although this principle is beneficial, the means ensuring the sealing of such a door are not easy to produce (due to their complex shape) and assemble.

Moreover, such a vehicle door also requires the assembly of a large number of parts, which is contrary to the objectives of reducing the weight and bulk of glazed devices.

### OBJECTIVES OF THE INVENTION

This invention is intended to resolve the weaknesses of said prior art.

The invention is intended to provide such a vehicle door having a flush-mounted appearance in itself and with vehicle bodies, and which has a good structural quality and seal.

More specifically, the invention is intended to provide a glazed device for producing a vehicle door that is simple to implement and assemble, for example, on an assembly line.

The invention is also intended to provide a method for producing a door for a motor vehicle that can be implemented simply and quickly.

In addition, the invention is intended to provide such a glazed device that can easily be maintained or replaced, for example, after an accident.

### DESCRIPTION OF THE INVENTION

These objectives, as well as others which will appear below, are achieved by a glazed device intended to be assembled to a door casing in order to form a motor vehicle door, with the glazed device including a frame having an upper cross member connecting two jambs each formed by a sliding mounted guide rail of at least one mobile glazed panel between a closed position and at least one open position, said mobile glazed panel having, on its face oriented toward the interior of the vehicle, at least one guide glide slidably mounted with respect to one of said guide rails.

According to the invention, the glazed device further comprises a sealing device having an upper portion forming said upper cross member of the frame, said upper portion of the sealing device bearing first sealing means intended to come into contact with the vehicle body when the door is closed, and second sealing means intended to come into contact with the mobile glazed panel.

Furthermore, said upper portion, the first sealing means of the door and the second sealing means of the glazing of the sealing device are manufactured from a single part.

Thus, a glazed device that is intended to be positioned on a door structure is produced simply by providing two sealing levels:
between the mobile glazed panel and the frame of the glazed device, the latter being formed by guide rails of the mobile glazed panel and a portion of the seal forming a cross member connecting the upper ends of the rails, and
between the frame of the glazed device and the vehicle body once the glazed device is mounted on the door structure and the door is attached to the vehicle.

It is thus possible to have an effective operation and a sealed closure, for each glazed device and each door, in spite of the tolerances necessary for the production and assembly of vehicles.

Furthermore, the sealing device is a single piece and is, for example, obtained via extrusion.

The upper portion thereof forming the cross member of the frame of the glazed device whereon is attached the guide rails is manufactured in a material chosen from . . . .

According to a particular aspect of the invention, said sealing device comprises two fastening lugs of the guide rails to said sealing device.

In a particular embodiment of the invention, the two fastening lugs are overmolded on said sealing.

According to a particular aspect of the invention, said sealing device comprises two branches extending parallel from the upper portion and each bearing first sealing means of a door and second sealing means of a glazing.

According to a particular aspect of the invention, each one of the two branches is integral with one of said guide rails.

In a particular embodiment of the invention, the branches are integral via clipping on said guide rails.

According to a particular aspect of the invention, the first sealing means are arranged on the upper face of the upper portion of the sealing device and in that the second sealing means are arranged on the lower face of the upper portion of the sealing device.

According to a particular aspect of the invention, said upper portion of the sealing device includes a slot in which an edge of the vehicle door casing is intended to be housed.

According to a particular aspect of the invention, said slot is located between the upper face and the lower face of said upper portion of the sealing device.

According to a particular aspect of the invention, the glazed device includes a lower cross member connecting the two guide rails in their lower portion and intended to be attached on the vehicle door casing.

The invention also relates to motor vehicle doors, including a glazed device according to the features described above, as well as motor vehicles including at least one such glazed device.

The invention also relates to a method for producing a motor vehicle door including the following steps:
production of a door casing;
production of a glazed device including at least one mobile glazed panel and guide rails by sliding of said mobile glazed panel between a closed position and at least one open position, said mobile glazed panel having, on its face oriented toward the interior of the vehicle, at least one guide glide slidably mounted with respect to one of said guide rails, said guide rails being connected in their upper portion by an upper cross member formed by the upper portion of a sealing device,
assembly of said door casing and said glazed device, the step of producing the glazed device including a step of producing, in a single piece, from the upper portion forming a cross member, first sealing means of a door intended to come into contact with the vehicle body when the door is closed, and of second sealing means intended to come into contact with the mobile glazed panel.

This method for producing a motor vehicle door can be implemented simply and quickly.

According to a particular aspect of the invention, the step of producing the glazed device further includes a step of placement of the guide rails on the two fastening lugs of the sealing device.

In a particular embodiment of the invention, the guide rails are fastened onto the two fastening lugs by screwing, riveting or clipping.

According to a particular aspect of the invention, the step of assembly of said door casing and of said glazed device comprises a step of inserting an edge of a door casing into a slot of said upper portion of the sealing device.

The invention also relates to a sealing device for a glazed device intended to be assembled to a door casing in order to form a motor vehicle door, with said glazed device comprising a frame that has an upper cross member connecting two jambs each formed by a sliding guide rail of at least one mobile glazed panel, between a closed position and at least one open position, said mobile glazed panel carrying, on its face oriented towards the inside of the vehicle, at least one guide glide mounted slidingly with respect to one of said guide rails, with the sealing device comprising an upper portion forming said cross member of the frame, said upper portion carrying first sealing means intended to come into contact with the body of the vehicle when the door is closed, and second sealing means intended to come into contact with the mobile glazed panel, said upper portion, with the first sealing means of the door and the second sealing means of the glazing being produced in a single piece.

### SUMMARY OF THE FIGURES

Other features and advantages of the invention will become clearer upon reading the following description of an embodiment of the invention, provided as a simple illustrative and non-limiting example, and the appended drawings, wherein:

FIG. 1 is an exploded view of the assembly forming the structure of a vehicle door according to the invention;

FIG. 2 is an exploded view of the glazed assembly of FIG. 1;

FIG. 3 is a cross-section view of the upper portion of a vehicle door according to the invention;

FIG. 4 is a cross-section view of the rear side portion of a vehicle door according to the invention;

FIG. 5 schematically illustrates the steps of an embodiment of the method for producing a motor vehicle door according to the invention.

### DETAILED DESCRIPTION OF AN EMBODIMENT

The invention therefore relates to a new technique making it possible to produce a motor vehicle door (side door, rear door, hatch, cabin door, and so on), the glazing, or mobile panel, of which is perfectly aligned and flush with the vehicle body.

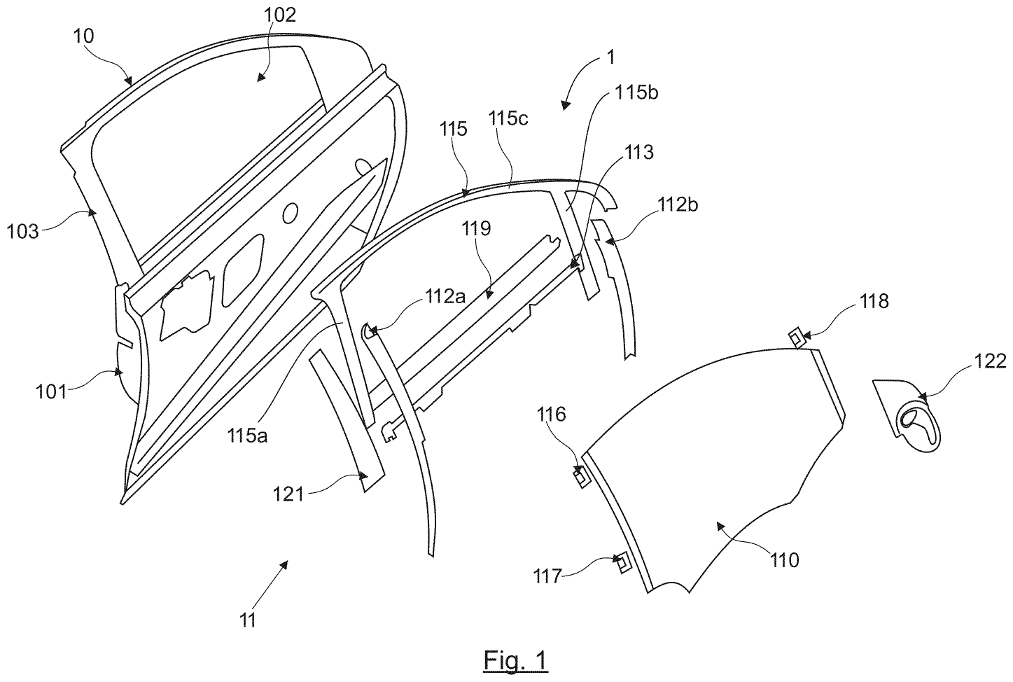

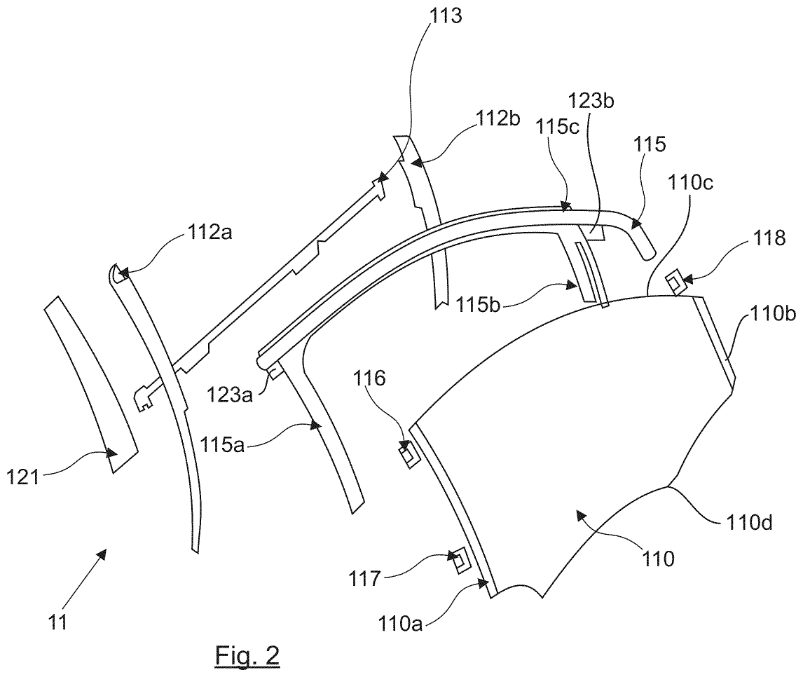

As shown in FIGS. 1 and 2, the embodiment described below relates to a front side door of a vehicle. However, of course, the same approach may be used on other doors of a vehicle.

Said motor vehicle door, and, in particular, the glazed portion thereof, is flush, i.e. no frame or frame element projects toward the outside of the vehicle, with respect to the plane of said glazed portion.

Said door 1 conventionally includes a door casing or chassis 10, forming the structure of said door. The casing 10 includes an upper frame 103, which defines an opening 102, and which is connected to a lower portion 101. In the figures, the exterior element of the vehicle body is omitted, so as to show the interior of the lower portion 101 of the casing 10, which includes in particular elements for receiving and holding the glazed portion 11.

Said glazed portion 11 is produced independently, as shown in FIG. 2, and then assembled to the casing 10, in order to form the door 1.

The glazed portion 11 includes a frame having an upper cross member formed by the upper portion 115_{C} of a seal 115, with the upper portion 115_{C} connecting two jambs each formed by a guide rail 112_{A}, 112_{B} by sliding a mobile glazed panel 110 and a central cross member 113.

The seal 115 has the form of a continuous strip. The curvature of its upper portion 115_{C} corresponds to that of the upper frame 103 of the casing 10, with this upper portion 115_{C} forming a cross member.

The seal 115 further comprises two straight branches 115_{A}, 1153 extending in parallel from this upper portion 115_{C}.

The mobile glazed panel, or glazing, 110, may be moved in a substantially vertical direction between:
a closed position, in which it closes the opening 102 formed in the upper frame 103 of the casing 10, its lower periphery 110_{D} remaining inserted in the thickness (i.e. in the lower portion 101) of the casing 10, the upper edge 110_{C} coming into contact with one or several sealing lips of the glazing 115_{E} which will be described below, the front 110_{B} and rear 110_{A} edges being located in the rails 112_{A}, 112_{B};
an open position, in which it frees the opening 102 and is completely or partially retracted in the thickness of the casing 10, and
intermediate positions.

It is noted that the rails 112_{A}, 112_{B} constitute, as the upper portion 115_{C} of the seal 115 when the latter is rigid, structural elements of the glazed portion 11.

The two rails 112_{A}, 112_{B}, which are made of plastic, aluminum, steel or any other suitable material, are mounted by screwing, riveting, clipping or any other suitable technique on two fastening lugs 123_{A}, 123_{B} integral with the seal 115.

The glazed portion 11 is assembled independently of the door casing 10, then mounted on the latter by attachment of the seal 115 forming the upper cross member and the rails 112_{A}, 112_{B} on the casing 10.

Thus, a door 1 capable of being mounted directly on the vehicle is obtained.

To ensure the seal between the casing 10 of the door 1 and the mobile glazed panel 110 when the latter is in the closed position (so as to prevent water or other elements from entering the vehicle), one or several sealing lips of glazing 115_{E} are provided on the peripheral seal 115 (called slide), and more particularly on the upper portion 115_{C} and the two branches 115_{A}, 115_{B} of the seal 115, which come into contact with the contour of the mobile glazed panel 110.

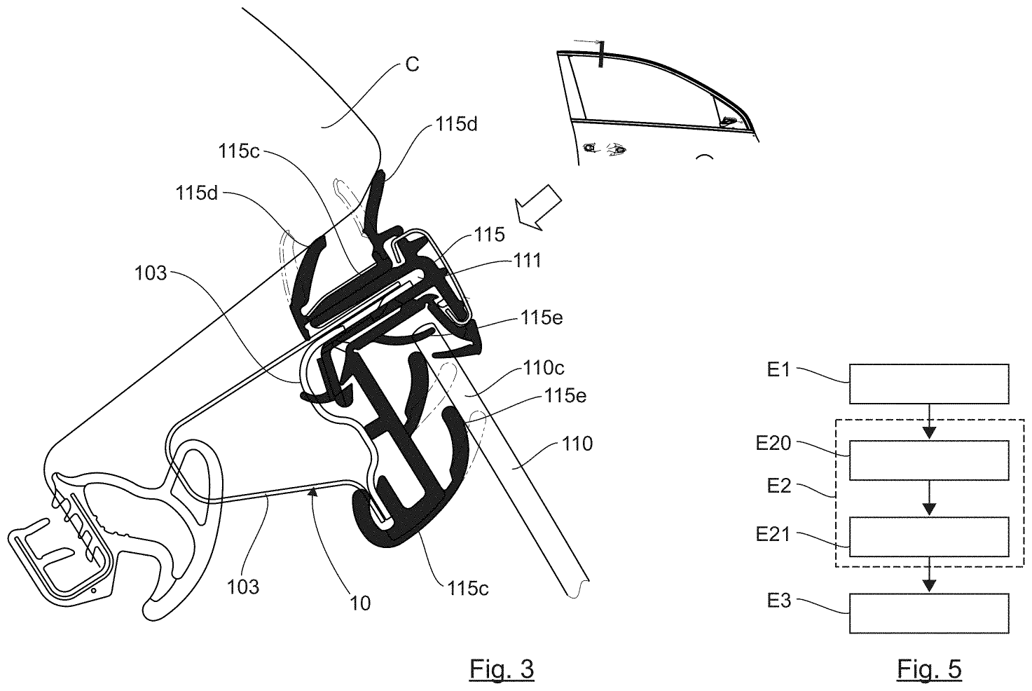

One or several sealing lips of the door 115d are arranged on the top (i.e. on the upper surface) of the upper portion 115_{C} in such a way as to be compressed between the upper portion 115_{C} of the seal 115 and the body of the vehicle (referenced as “C” in FIG. 3) when the door 1 is closed, which provides a good seal.

The sealing lip or lips of the door 115d and the sealing lip or lips of the glazing 115e are produced in a single piece with the upper portion 115_{C} and the two branches 115_{A}, 115_{B}.

The upper portion 115_{C} of the seal 115 is either rigid and then forms a structuring element that has a relatively high mechanical resistance and exerting a rigidifying function of the frame, or flexible.

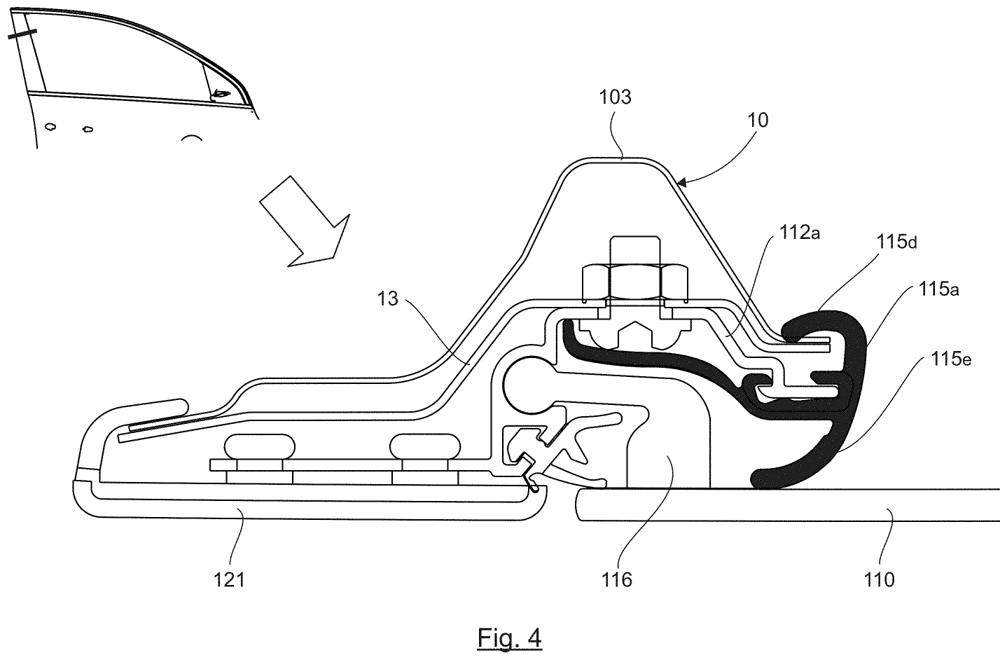

As shown in the cross-section views of FIGS. 3 and 4, the glazing sealing lip or lips 115e are attached on the bottom (i.e. on the lower surface) of the upper portion 115_{C} and on and on the inner edge of the rails 112_{A}, 112_{B}, so as to be concealed below the mobile glazed panel 110 when it is closed.

The glazing seal lip or lips 115e are then compressed between the upper frame 103 of the casing 10 and the mobile glazed panel 110, which ensures a good seal.

It is noted that, in the example shown in FIG. 3, that the four glazing sealing lips 115e come into contact with the upper edge 110_{C} of the mobile glazed panel 110, which is closed.

It is also noted that, in FIG. 3, that the upper portion 115_{C} of the seal 115 has a U-shaped interior groove 111, in which an edge of the upper frame 103 of the casing 10 is housed during assembly of the glazed portion 11 on the casing 10.

The mobile glazed panel 110 is moved by driving means (not shown), for example a rack mechanism, itself actuated by an electric motor. Other driving means, including manual driving means, may of course be implemented.

Guide glides are attached on the face of the mobile glazed panel 110 oriented toward the interior of the vehicle. Said guide glides are intended to cooperate with rails 112_{A}, 112_{B} and guide the rear 110_{A} and front 110_{B} edges of the mobile glazed panel 110 in the rails 112_{A}, 112_{B}. In practice, said glides are not generally visible from the outside (the corresponding area being screen-printed). In this embodiment, two glides 116 and 117 are intended to cooperate with the rail 112_{A} oriented toward the rear, and a single glide 118 is intended to cooperate with the rail 112_{B} oriented toward the front.

The guide rails 112_{A}, 112_{B} ensure the dual function of guiding in translation and tacking. Said tacking, which is not imperative in all embodiments, makes it possible to slightly offset the mobile glazed panel 110 toward the outside, before it is moved in translation, so as to release it from the seal 115, in order to facilitate the movement and limit the deterioration of the latter.

It is noted that, in FIG. 4, the glide 116 attached to the mobile glazed panel 110 is arranged in the rail 112_{A} and the branch 115_{A} of the seal 115 is clipped to the edge of the rail 112_{A} oriented toward the mobile glazed panel 110.

The branch 115_{A} of the seal 115 has a first glazing lip 115e coming into contact with the rear edge 110_{A} of the mobile glazed panel 110, which is closed, and a second door lip 115d covering the frame of the casing 10.

It is understood that, similarly, the branch 115_{B} of the glazing seal 115 located on the rail 112_{B}, has a glazing lip 115e coming into contact with the front edge 110_{B} of the mobile glazed panel 110 and a door lip 115d covering the frame of the casing 10.

The frame of the glazed portion 11 also has:
a central cross member 113 connecting the guide rails 112_{A}, 112_{B} and which is screwed, for example, to the top of the lower portion 101 of the casing 10, and
a seal, namely an interior tongue 119 (attached to the central cross member 113) which is intended to come into contact with the interior surface of the mobile glazed panel 110, and which is intended to prevent water or other elements from entering the thickness of the casing 10.

The frame of the glazed portion 11 also has, in this example, a cap element 121 extending in the plane of the mobile glazed panel 110 when it is in the closed position, and an exterior rearview mirror base 122.

The door may have a shade.

The glazed assembly may also include one or more fixed glazed panel(s) or quarter panel(s).

In a specific embodiment, the mobile glazed panel has, on its face oriented toward the interior of the vehicle, two guide glides each slidably mounted with respect to a guide rail.

In another particular embodiment, the mobile glazed panel has a single guide glide cooperating with one of the two guide rails in which the mobile glazed panel slides.

FIG. 5 schematically shows the steps of an embodiment of the method for producing a motor vehicle door according to the invention.

In this example, the method includes the following steps:
production (step E1) of a door casing 10;
production (step E2) of a glazed device 11 including at least one mobile glazed panel 110 and guide rails 112_{A}, 112_{B} by sliding the mobile glazed panel 110 between a closed position and at least one open position, with the mobile glazed panel 110 having, on its face oriented toward the interior of the vehicle, at least one guide glide 116, 117, 118 slidably mounted with respect to one of the guide rails 112_{A}, 112_{B}, said guide rails 112_{A}, 112_{B} being connected in their upper portion by an upper cross member formed by the upper portion 115_{C} of a seal 115,
assembly (step E3) of the door casing 10 and of the glazed device 11.

It is noted that the step (E2) of producing the glazed device 11 includes:
a step of producing (E20), in a single piece, the upper portion 115_{C} forming a cross member and two branches 115_{A}, 115_{B} of the seal 115, with the upper portion 115_{C} carrying one or more sealing door lips 115d, and one or more glazing sealing lips 115e.
a step of placing (E21) guide rails 112_{A}, 112_{B} on two fastening lugs 123_{A}, 123_{B} of the seal 115, with the guide rails (112_{A}, 112_{B}) being attached to two fastening lugs 123_{A}, 123_{B} by screwing, riveting or clipping, for example.

Note moreover that the step of assembling (E3) of the casing of the door 10 and of the glazing device 11 comprises a step of inserting an edge of the casing of the door 10 into the slot 111_{A} of the upper portion 115_{C} of the sealing device 115.

Numerous additions or alternatives to the embodiment described above may of course be envisaged.

1. Glazed device (11) intended to be assembled with a door casing (10) for forming a motor vehicle door (1), including a frame having an upper cross member connecting two jambs each formed by a sliding guide rail (112_{A}, 112_{B}) of at least one mobile glazed panel (110) between a closed position and at least one open position, said mobile glazed panel (110) having, on its face oriented toward the interior of the vehicle, at least one guide glide (116, 117, 118) slidably mounted with respect to one of said guide rails (112_{A}, 112_{B}),
the glazed device (11) further comprising at least one sealing device (115) comprising a rigid upper portion (115_{C}) forming said upper cross member of the frame, said rigid upper portion (115_{C}) carrying first sealing means (115d) intended to come into contact with the vehicle body (C) when the door (1) is closed, and second sealing means (115e) intended to come into contact with the mobile glazed panel (110),
said rigid upper portion (115C), the first door sealing means (115d) and the second glazing sealing means (115e) being made of a single piece,
the glazed device (11) being characterized in that said sealing device (115) comprises two fastening lugs (123_{A}, 123_{B}) of the guide rails (112_{A}, 112_{B}) to said sealing device (115).

2. (canceled)

3. Glazed device (11) according to claim 21, characterized in that the two fastening lugs (123_{A}, 123_{B}) are overmolded on said sealing device (115).

4. Glazed device (11) according to claim 1, characterized in that said sealing device (115) comprises two branches (115_{A}, 115_{B}) extending parallel from the rigid upper portion (115_{C}) and each carrying first door sealing means (115d) and second glazing sealing means (115e).

5. Glazed device (11) according to claim 4, characterized in that each one of the two branches (115_{A}, 115_{B}) is integral with one of said guide rails (112_{A}, 112_{B}).

6. Glazed device (11) according to claim 5, characterized in that the branches (115_{A}, 115_{B}) are made integral via clipping on said guide rails (112_{A}, 112_{B}).

7. Glazed device (11) according to claim 1, characterized in that the first sealing means (115d) are arranged on the upper face (111B) of the rigid upper portion (115_{C}) of the sealing device (115) and in that the second sealing means (115) are arranged on the lower face (111_{C}) of the rigid upper portion (115_{C}) of the sealing device (115).

8. Glazed device (11) according to claim 1, characterized in that said rigid upper portion (115_{C}) of the sealing device (115) includes a slot (111_{A}) in which an edge of the door casing (10) is intended to be housed.

9. Glazed device (11) according to claim 8, characterized in that said slot (111_{A}) is located between the upper face (111_{B}) and the lower face (111_{C}) of said rigid upper portion (115_{C}) of the sealing device (115).

10. Glazed device (11) according to claim 1, characterized in that it includes a lower cross member (113) connecting the two guide rails (112_{A}, 112_{B}) in their lower portion and intended to be attached to the door casing (10).

11. Motor vehicle door (1), characterized in that it includes a glazed device (11) according to claim 1.

12. Motor vehicle, characterized in that it includes at least one glazed device (11) according to claim 1.

13. Method for producing a motor vehicle door (1), characterized in that it includes the following steps:
production (E1) of a door casing (10);
production (E2) of a glazed device (11) including at least one mobile glazed panel (110) and guide rails (112_{A}, 112_{B}) by sliding said mobile glazed panel (110) between a closed position and at least one open position, said mobile glazed panel (110) having, on its face oriented toward the interior of the vehicle, at least one guide glide (116, 117, 118) slidably mounted with respect to one of said guide rails (112_{A}, 112_{B}), said guide rails (112_{A}, 112_{B}) being connected in their upper portion by an upper cross member formed by the upper portion (115_{C}) of a sealing device (115),
assembly (E3) of said door casing (10) and said glazed device (11),
said step (E2) of producing the glazed device (11) including a step of production (E20), in a single piece, of the rigid upper portion (115_{C}) forming a cross member, of first door sealing means (115d) intended to come into contact with the vehicle body when the door (1) is closed, and second glazing sealing means (115e) intended to come into contact with the mobile glazed panel (110),
said method being characterized in that the step of manufacturing (E2) of producing the glazed device (11) further comprises a step of placing (E21) of the guide rails (112_{A}, 112_{B}) on the fastening lugs (123_{A}, 123_{B}) of the sealing device (115).

14. Production method according to claim 13, characterized in that the guide rails (112_{A}, 112_{B}) are fastened on the fastening lugs (123_{A}, 123_{B}) by screwing, riveting or clipping.

15. (canceled)

16. Production method according to claim 13, characterized in that the step of assembly (E3) of said door casing (10) and of said glazed device (11) comprises a step of inserting an edge of the door casing (10) into a slot (111_{A}) of said upper portion (115_{C}) of the sealing device (115).

17. Sealing device (115) for a glazed device (11) intended to be assembled to a door casing (10) in order to form a vehicle door (1), with the glazed device (11) comprising a frame having an upper cross member connecting two jambs each formed by a sliding guide rail (112_{A}, 112_{B}) of at least one mobile glazed panel (110), between a closed position and at least one open position, said mobile glazed panel (110) carrying, on its face oriented towards the inside of the vehicle, at least one guide glide (116, 117, 118) mounted slidingly with respect to one of said guide rails (112_{A}, 112_{B}),
with the sealing device (115) comprising a rigid upper portion (115_{C}) forming said upper cross member of the frame, said rigid upper portion (115_{C}) carrying first sealing means (115d) intended to come into contact with the body of the vehicle when the door (1) is closed, and second means of sealing (115e) intended to come into contact with the mobile glazed panel (110),
said rigid upper portion (115_{C}), the first door sealing means (115d) and the second glazing sealing means (115e) are being manufactured in a single piece,
the sealing device (115) being characterized in that it comprises two fastening lugs (123_{A}, 123_{B}) of the guide rails (112_{A}, 112_{B}) to said sealing device.
